(19) United States
(12) Patent Application Publication
(10) Pub. No.: US 2014/0198977 A1
(43) Pub. Date: Jul. 17, 2014

(54) Enhancement of Stereo Depth Maps

(71) Applicant: Texas Instruments Incorporated, (US)

(72) Inventors: Rajesh Narasimha, Plano, TX (US); Karthik Jayaraman Raghuram, Santa Clara, CA (US); Jesse Gregory Villarreal, JR., Richardson, TX (US); Roman Joel Pacheco, Leander, TX (US)

(73) Assignee: Texas Instruments Incorporated, Dallas, TX (US)

(21) Appl. No.: 13/848,697

(22) Filed: Mar. 21, 2013

Related U.S. Application Data
(60) Provisional application No. 61/613,602, filed on Mar. 21, 2012.

(51) Int. Cl. G06K 9/62; G06T 7/00

(52) U.S. Cl. CPC G06K 9/6212; G06T 7/0075
USPC 382/154

(57) ABSTRACT

A method for computation of a depth map for corresponding left and right two dimensional (2D) images of a stereo image is provided that includes determining a disparity range based on a disparity of at least one object in a scene of the left and right 2D images, performing color matching of the left and right 2D images, performing contrast and brightness matching of the left and right 2D images, and computing a disparity image for the left and right 2D images after the color matching and the contrast and brightness matching are performed, wherein the disparity range is used for correspondence matching of the left and right 2D images.

### CROSS-REFERENCE TO RELATED APPLICATIONS

This application claims benefit of U.S. Provisional Patent Application Ser. No. 61/613,602, filed Mar. 21, 2012, which is incorporated herein by reference in its entirety.

### BACKGROUND OF THE INVENTION

1. Field of the Invention

Embodiments of the present invention generally relate to enhancing low quality stereo depth maps.

2. Description of the Related Art

More and more 3D stereoscopic imaging and augmented reality based applications are being developed for hand-held devices. In such applications, the quality of the depth map generated from image pairs is key for an acceptable user experience. The accuracy and density of generated depth maps are important along with meeting real-time constraints on a resource constrained embedded system.

### SUMMARY

Embodiments of the present invention relate to methods, apparatus, and computer readable media for depth map computation. In one aspect, a method for computation of a depth map for corresponding left and right two dimensional (2D) images of a stereo image is provided that includes determining a disparity range based on a disparity of at least one object in a scene of the left and right 2D images, performing color matching of the left and right 2D images, performing contrast and brightness matching of the left and right 2D images, and computing a disparity image for the left and right 2D images after the color matching and the contrast and brightness matching are performed, wherein the disparity range is used for correspondence matching of the left and right 2D images.

In one aspect, a stereo image processing system is provided that includes a first imaging component arranged to capture a left two-dimensional (2D) image of a scene, a second imaging component arranged to capture a right 2D image of a scene, means for performing color matching of the left and right 2D images, wherein performing color matching includes computing an average R value, an average G value, and an average B value for each of a reference block of pixels in a reference image and a non-reference block of pixels in a non-reference image, wherein the reference image is one of the left 2D image and the right 2D image and the non-reference image is another of the left 2D image and the right 2D image, and wherein the non-reference block of pixels is a block of pixels in the non-reference image corresponding to the reference block of pixels, computing an R gain, a G gain, and a B gain as respective ratios of the average R values of the non-reference block of pixels and the reference block of pixels, the average G values of the non-reference block of pixels and the reference block of pixels, and the average B values of the non-reference block of pixels and the reference block of pixels, and applying the R gain, the G gain, and the B gain to the non-reference image, means for performing contrast and brightness matching of the left and right 2D images, and means for computing a disparity image for the left and right 2D images after the color matching and the contrast and brightness matching are performed.

In one aspect, a non-transitory computer-readable medium storing software instructions is provided. The software instructions, when executed by a processor, perform a method for computation of a disparity map that includes performing color matching of the left and right 2D images, performing contrast and brightness matching of the left and right 2D images, and computing a disparity image for the left and right 2D images after the color matching and the contrast and brightness matching are performed, wherein computing a disparity image includes computing a first disparity image at a first resolution, computing a second disparity image at a second resolution, wherein the second resolution is lower than the first resolution, upsampling the second disparity image to the first resolution, and filling holes in the first disparity image by interpolating disparity values in selected areas in the first disparity image with disparity values in corresponding selected areas in the upsampled second disparity image.

### BRIEF DESCRIPTION OF THE DRAWINGS

Particular embodiments will now be described, by way of example only, and with reference to the accompanying drawings:

FIG. 1 is a block diagram of a stereo image processing system;

FIGS. 2-12 and 14-16 are examples;

FIGS. 13 and 17 are flow diagrams of methods; and

FIG. 18 is a block diagram of an illustrative digital system;

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As previously mentioned, the quality of the depth map generated for stereoscopic image pairs is key to the quality of the displayed three-dimensional (3D) image. Objects at different depths in the scene of a stereoscopic video sequence or a stereoscopic still picture will have different displacements, i.e., disparities, in left and right frames of the stereoscopic video sequence or stereoscopic still picture, thus creating a sense of depth when the stereoscopic images are viewed on a stereoscopic display. As used herein, a frame is a complete image captured during a known time interval.

The term disparity refers to the shift that occurs at each pixel in an image between the left and right images due the different perspectives of the cameras used to capture the two images. The amount of shift or disparity may vary from pixel to pixel depending on the depth of the corresponding 3D point in the scene. Further, the depth of a pixel in the 3D scene of each frame of a stereoscopic video sequence or a still stereoscopic picture is inversely proportional to the disparity of that pixel between the corresponding left and right images and thus may be computed from the disparity. More specifically, a depth map or depth image for each frame of a stereoscopic video sequence or a stereoscopic still picture that represents the depth of each pixel in the image may be computed based on the disparity of the pixels between the corresponding left and right images in two two-dimensional (2D) video sequences or two 2D left and right still pictures.

To determine the pixel disparities, a stereo matching algorithm, also referred to as a stereo correspondence algorithm is used. The accuracy of disparity estimation using a stereo matching algorithm is dependent on factors such as the content in the scene, characteristics of the imaging sensors used, and the illumination in the scene. Some of the common problems encountered are photometric variations and field of view variations between the left and right image pairs, sensor noise, and content in the scene such as specularities, reflections, transparent regions, textureless regions, repetitive structures and textures, and occlusions. All these factors can contribute to unreliable disparity estimation or result in holes (no disparities) in the disparity images.

Embodiments of the invention provide for improving the quality of depth maps (images) generated from left and right corresponding 2D images while meeting throughput requirements. In some embodiments, the disparity search range to be used by the stereo correspondence algorithm is dynamically determined for each stereo image pair based one or more objects of interest in the scene. In such embodiments, the dynamically determined disparity search range may be narrower than the full disparity search range. Having a smaller search range decreases the computational cost of the stereo correspondence algorithm. In some embodiments, color and contrast matching is performed on the left and right corresponding 2D images to correct for color and contrast differences between the two images. In some embodiments, a multiple-resolution approach to computing the depth map is used to fill holes in the disparity image (map). In some embodiments, post-processing is performed on the depth map to further improve the quality.

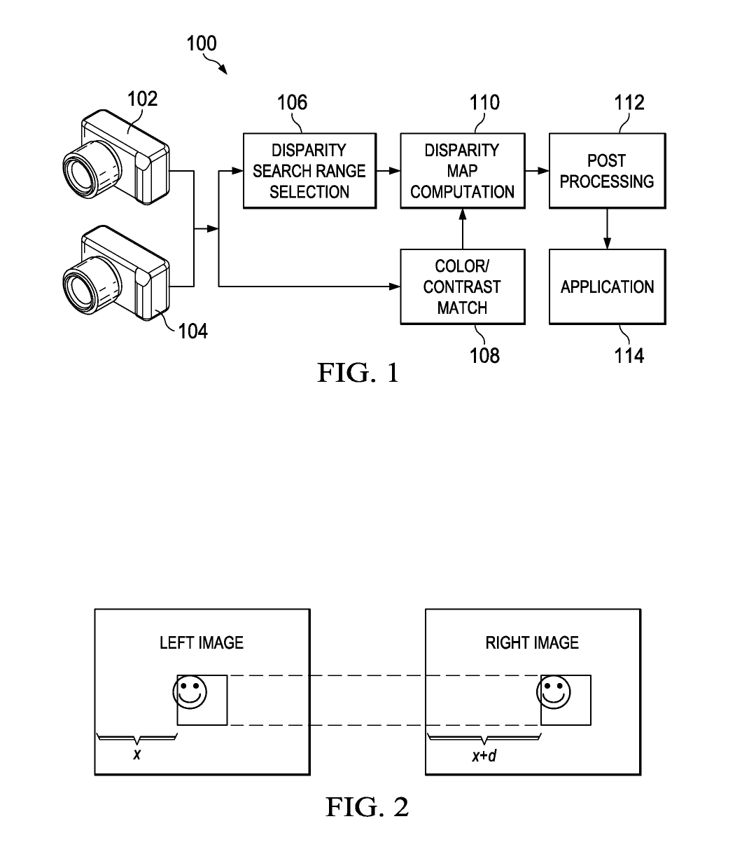

FIG. 1 is a block diagram of a stereo image processing system 100. The system 100 includes left and right imaging components (cameras) 102, 104, a disparity search range selection component 106, a color/contrast match component 108, a disparity map computation component 110, a post-processing component 112, and application component 114. The components of the stereo image processing system 100 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, software instructions may be stored in memory (not shown) and executed by one or more processors.

The left and right imaging components 102, 104 include imaging sensor systems arranged to capture image signals of a scene from a left viewpoint and a right viewpoint. That is, the imaging sensor system of the left imaging component 102 is arranged to capture an image signal from the left viewpoint, i.e., a left analog image signal, and the imaging sensor system of the right imaging component 104 is arranged to capture an image signal from the right view point, i.e., a right analog image signal. Each of the imaging sensor systems may include a lens assembly, a lens actuator, an aperture, and an imaging sensor. The imaging components 102, 104 also include circuitry for controlling various aspects of the operation of the respective image sensor systems, such as, for example, aperture opening amount, exposure time, etc. The imaging components 102, 104 also include functionality to convert the respective left and right analog image signals to left and right digital image signals and to apply suitable image signal processing techniques, e.g., image smoothing, de-noising, etc., to the images. The left and right digital image signals are provided to the object detection component 106 and the color/contrast match component 110.

The disparity range selection component 106 includes functionality to determine a disparity search range, i.e., a minimum disparity dmin and a maximum disparity dmax, to be used by the stereo correspondence algorithm that generates the disparity map. This disparity range is determined based on the objects present in the scene captured by corresponding left and right images. That is, suitable object detection is performed and a disparity search range is derived from one or more detected objects. The determined disparity search range maybe narrower than the default search range. If no objects are detected, the default disparity range is used.

For many applications, the area of interest in a stereo image is the area containing objects that would be detected by an object detection algorithm. This area of interest typically has a disparity range narrower than that of the full disparity range available to the stereo correspondence algorithm. Further, the disparity range may change over time because the objects of interest may be closer or more distant. The computational cost of the determining a disparity map is proportional to the disparity search range. Thus, narrowing the disparity search range dynamically based on object detection (provided the object detection is suitably fast) may decrease the overall computational time needed to determine a disparity map.

In some embodiments, the disparity range selection component 106 uses a suitable object detection technique to locate an object of interest in each of the left and right images and the disparity of the object is used to determine the correspondence search disparity range. The disparity between the object in the left and right images is calculated by subtracting the horizontal offset of the bounding box of the object in one of the images from the horizontal offset the bounding box of the same object in the other image. For example, as shown in FIG. 2, the object detection algorithm may return the bounding box of a face in each to the left and right 2D images. The disparity of this face is calculated by subtracting the horizontal offset of the bounding box of the face from the horizontal offset of the bounding box of the face in the other image. The horizontal offset of a bounding box is the number of pixels from the left edge of the 2D image to a selected pixel in the bounding box. The selected pixel may be, for example, the center pixel of the bounding box, a pixel at the left edge of the bounding box, or a pixel at the right edge of the bounding box.

The disparity between the two bounding boxes, d0, is then used to define the correspondence search disparity range, i.e., a minimum disparity dmin and a maximum disparity dmax, to be used by the stereo correspondence algorithm. The values for dmin and dmax may be determined based on d0 in any suitable way and the determination may depend on the particular application using the final depth map. In some embodiments, a constant search range around d0 is used. For example, if d0=30 pixels and the constant search range is +/−8 pixels, the resulting values for the disparity range are dmin=22 and dmax=38. In another example, in some embodiments, the search range may be determined based on maintaining a constant distance range from the object detected.

If multiple objects are present, the particular object or objects used to determine the disparity range may depend on the application using the resulting depth map. For example, in some embodiments, the closest object, regardless of type, is used to determine the disparity range. In some embodiments, the closest object of a particular type of interest to the end application is used to determine the disparity range.

In some embodiments, the disparities of multiple objects in the scene may be considered in the determination of the disparity range. In some such embodiments, the value of dmin is derived based on to the smallest value of d0 among the multiple objects and the value of dmax is derived based on the largest value of d0, i.e.,

dmin=MIN(d0)−margin

dmax=MAX(d0)+margin

where the value of margin is an additional number of pixels used to pad the disparity range. The value of margin may be any suitable value, e.g., a pre-determined constant selected for the application receiving the disparity map.

In other such embodiments, dmin and dmax for each object are obtained independently using the disparities (d0) of the bounding boxes of each object found. The dmin/dmax ranges that overlap, or are sufficiently close to each other, are combined into a single range. If there are ranges that are sufficiently separated to justify running a disparity map computation on each separate range, then separate disparity map computations are performed for each dmin/dmax. That is, the multiple ranges are provided to the disparity map computation component 110 to be used in computing the final disparity map. Computation of a final disparity map using multiple disparity ranges is describe in more detail herein in reference to the disparity map computation component 110.

For example, assume that four objects of interest O1, O2, O3, and O4, are detected with values of dmin and dmax as follows: O1(8,24), O2(100,108), O3(106,114), and O4(116,122). In this example, there is the option to combine the disparity ranges of O2 and O3 as the ranges of these objects overlap, and the option to combine the disparity range of O4 with those of O2 and O3, as the range of O4 is sufficiently close. Thus, there are two disparity ranges that are sufficiently separated to justify running separate disparity map computations: O1(8,24) and O234(100,122). These two ranges are then used for computation of the final disparity map.

In some embodiments, the disparity range selection component 106 determines the disparity range using one of the left or right images of the stereo pair. More specifically, the disparity range selection component 106 calculates a disparity by comparing the size of an object in the image to the expected size at different distances from the camera, i.e., by using a combination of the “distance to size” function and the “distance to disparity” function derived from the basic equations:

D=af/s (distance to size)

D=bf/d (distance to disparity)

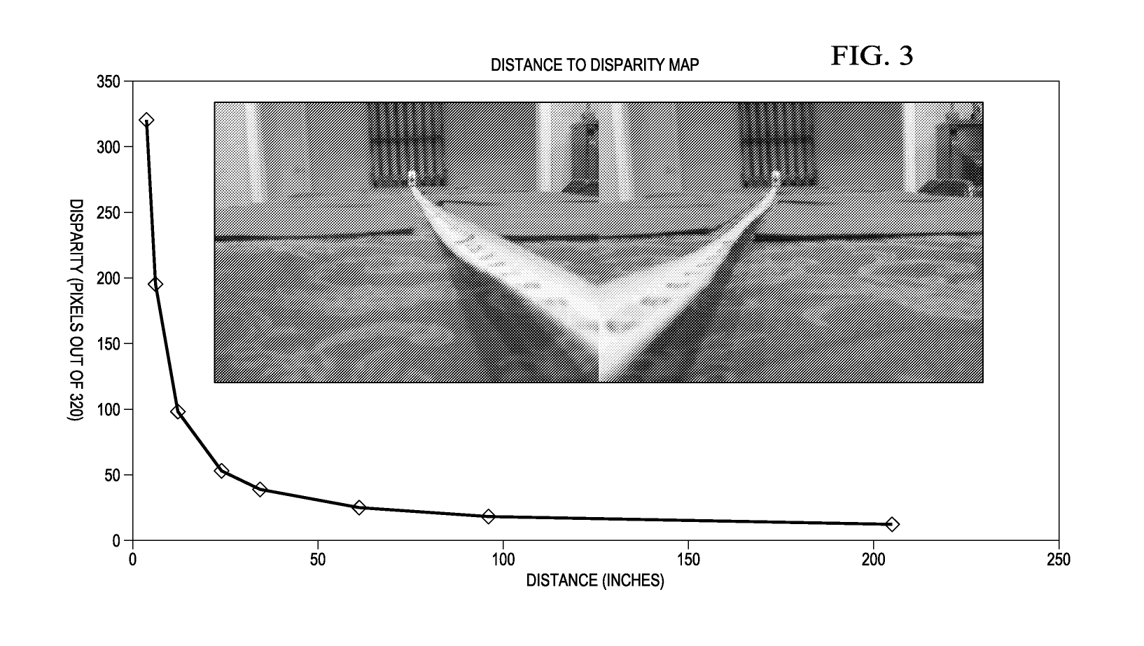

d=bs/a (disparity to size)

where D is the distance of a point in the real world, a is the actual object size, s is the image
object size, b and f are the base offset and focal length of the camera, and d is the disparity. Any suitable object detection algorithm (e.g., a face detection algorithm) may be used to locate an object in the single image. The computation may be performed, for example, using a pre-determined equation or a pre-determined lookup table. FIG. 3 is an example of a distance to disparity function. The calculated disparity may used to determine the correspondence search disparity range as previously described. The presence of multiple objects may be handled as previously described.

The color/contrast match component 108 includes functionality to match the color and the brightness and contrast in a reference image of the pair of 2D images to that the other image. For simplicity of explanation, the reference image is assumed to the left image. One of ordinary skill in the art will understand embodiments in which the reference image is the right image. Stereo correspondence algorithms used to match left and right images for determining disparity are susceptible to intensity differences between pixels in the two images. The differences in color, brightness, and contrast may occur due to factors such as low cost image sensors, mismatches in the imaging pipeline or differences in mechanical elements of the cameras such as auto focus, aperture and auto exposure. Correcting for these differences improves the quality of the stereo correspondence search, which in turn improves the final depth image.

The color/contrast match component 108 performs color matching, followed by brightness/contrast matching. One of ordinary skill in the art will understand embodiments in which this ordering is reversed. For color matching, a gain for each of the R, G, and B values is computed as the ratio of the average R, G, and B values of a sufficiently large area in the left image and the average R, G, and B values of a corresponding area in the right image. These gains are then applied to the R, G, and B values of the right image to match the colors to the left image. For example, the area in the left image may be a square block of size M×M, where M is a percentage of the width of a P×Q image. For example, the percentage may be 10%. Thus, if the image size is 640*480, 10% of the width of 640 is 64 and the square block would be 64*64. The particular dimensions of the block may be empirically pre-determined for an application.

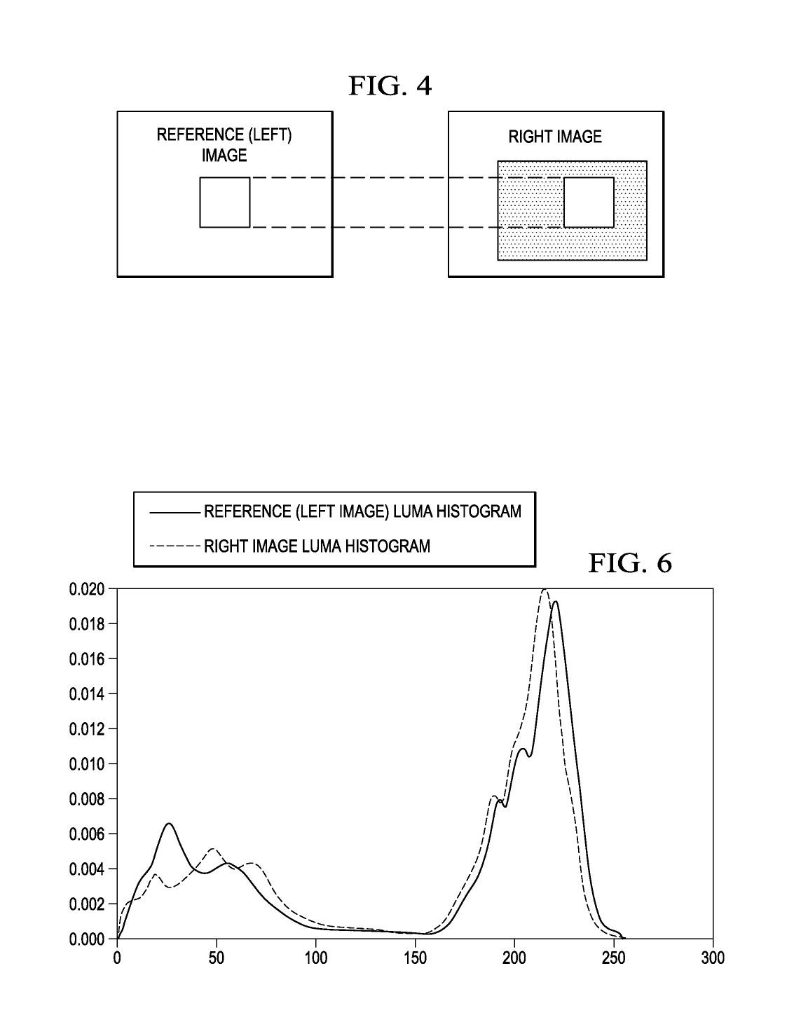

To find the corresponding block in the right image, the right image is searched within a predetermined search area for a matching block. The size of the predetermined search area may be empirically pre-determined for a particular application. Any suitable correspondence search may be used to determine the best matching block in the right image. In some embodiments, a sum of absolute differences (SAD) search is used in which a SAD between the reference block and a candidate matching block is computed as a measure of how well the two blocks match. In some embodiments, the sum of squares of the absolute differences is used. An example is shown in FIG. 4, where the small square block in the left image is matched to a block in the right image. The “shaded” area in the right image is the search area considered to find the matching block.

After the best matching block in the right image is located, the average R (red) value, the average G (green) value, and the average B (blue) value of the reference block are computed and the same averages are computed for the matching block. A gain for each of R, G, and B between the right image and the left (reference) image are then computed as follows:

Rgain=Ravg_right/Ravg_ref

Ggain=Gavg_right/Gavg_ref

Bgain=Bavg_right/Bavg_ref

where Ravg_right, Gavg_right, and Bavg_right are the R, G, and B averages for the matching block in the right image and Ravg_ref, Gavg_ref, and Bavg_ref are the R, G, and B averages for the reference block in the left image.

The gains are then applied to the R, G, and B values of each pixel in the right image as follows to scale the R, G, and B values to better match with the left image:

R=R/Rgain

G=G/Ggain

B=B/Bgain

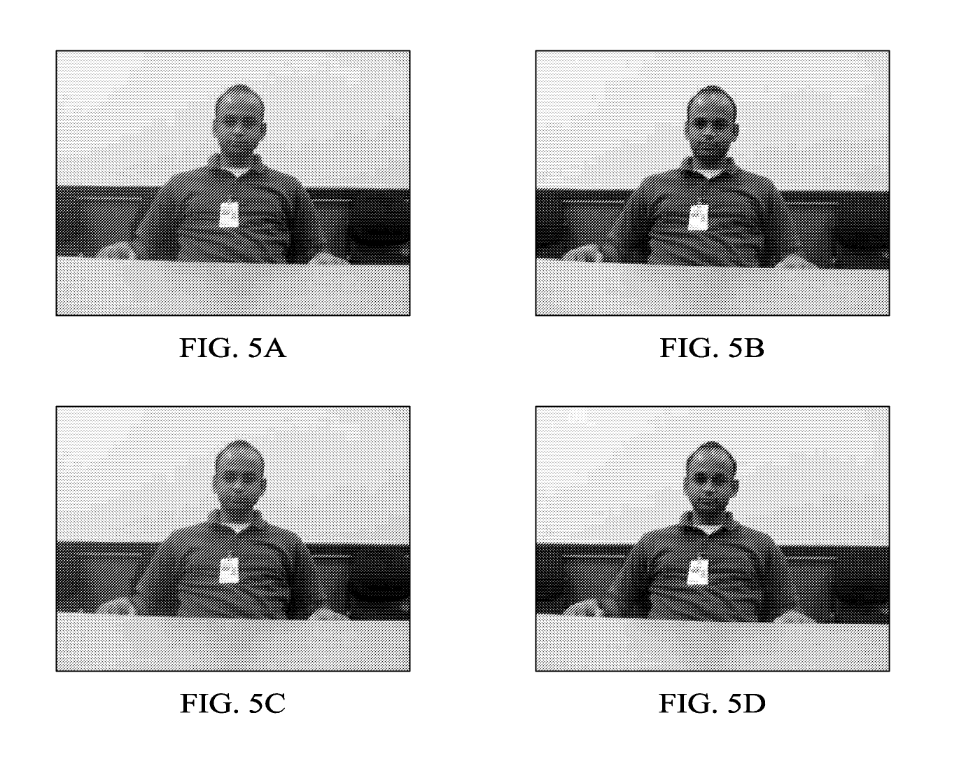

FIGS. 5A-5D are an example illustrating the results of applying this color matching technique. FIGS. 5A and 5B show, respectively, the original left and right images, and FIGS. 5C and 5D show, respectively, the left and right images after the color matching.

Referring again to FIG. 1, after the color matching is performed, the color/contrast match component 108 then matches the contrast and brightness between the two images. The contrast matching method used is based on matching the luminance histograms of the left and right image pair. Initially, the luminance histogram of the left image, i.e., the reference histogram, and the luminance histogram of the right image are computed. A mapping function expressed in the form of a mapping lookup table (LUT) is then computed that matches the right luminance histogram to the left luminance histogram. To compute this mapping function, the cumulative distribution function (CDF) from the left luminance histogram and the CDF from the right luminance histogram are computed. A mapping LUT is then generated to match the right CDF to the left CDF, and the mapping LUT is modified as needed to insure that the mapping values are monotonically increasing. The mapping LUT is then used to adjust brightness and contrast at each pixel in the right image to more closely match the left image.

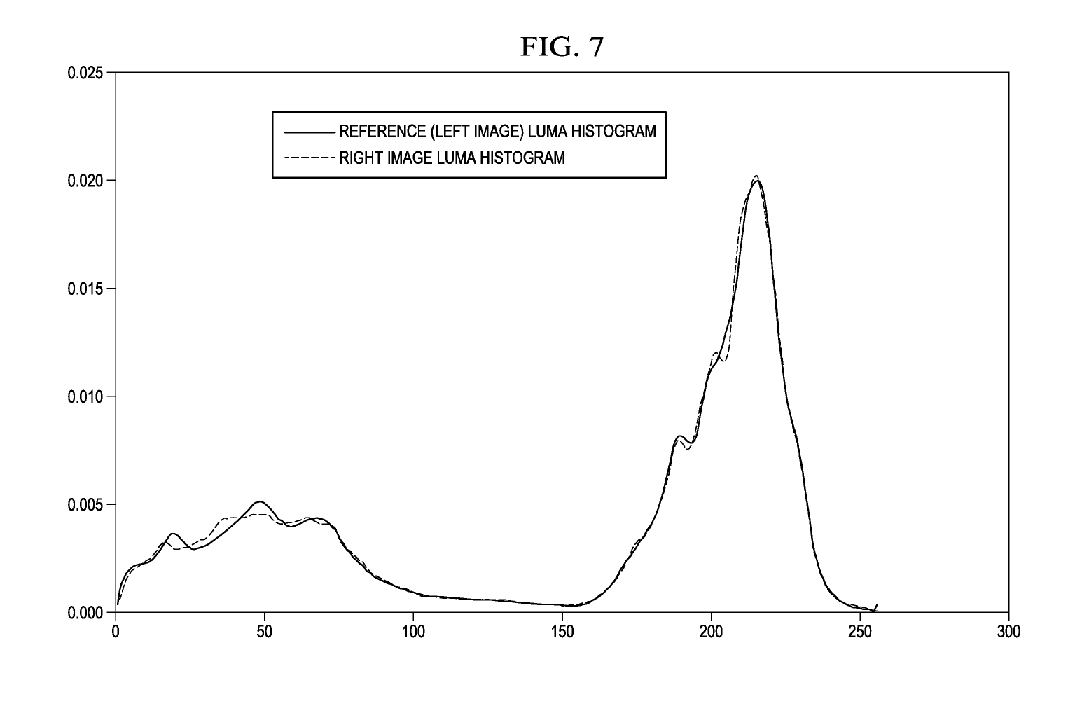

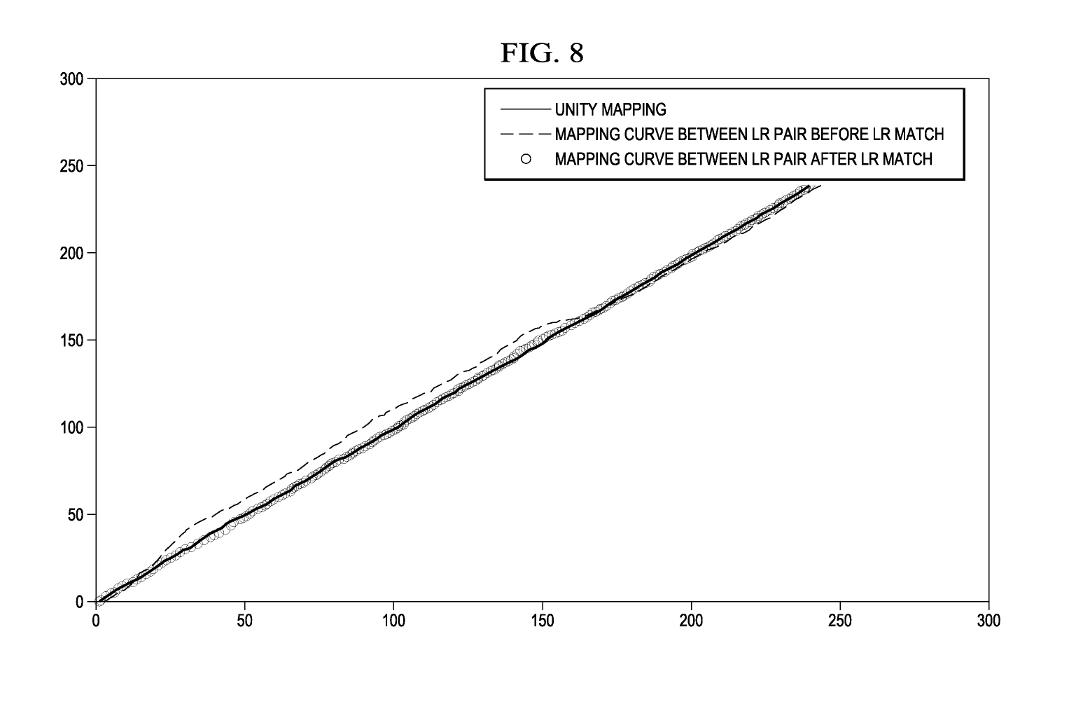

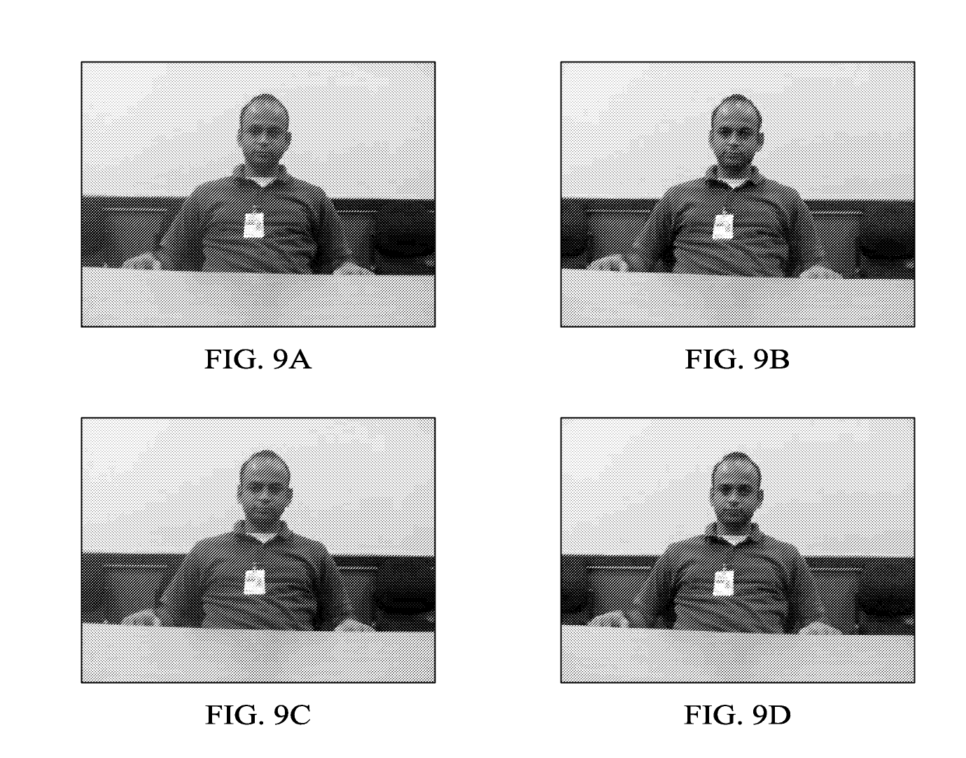

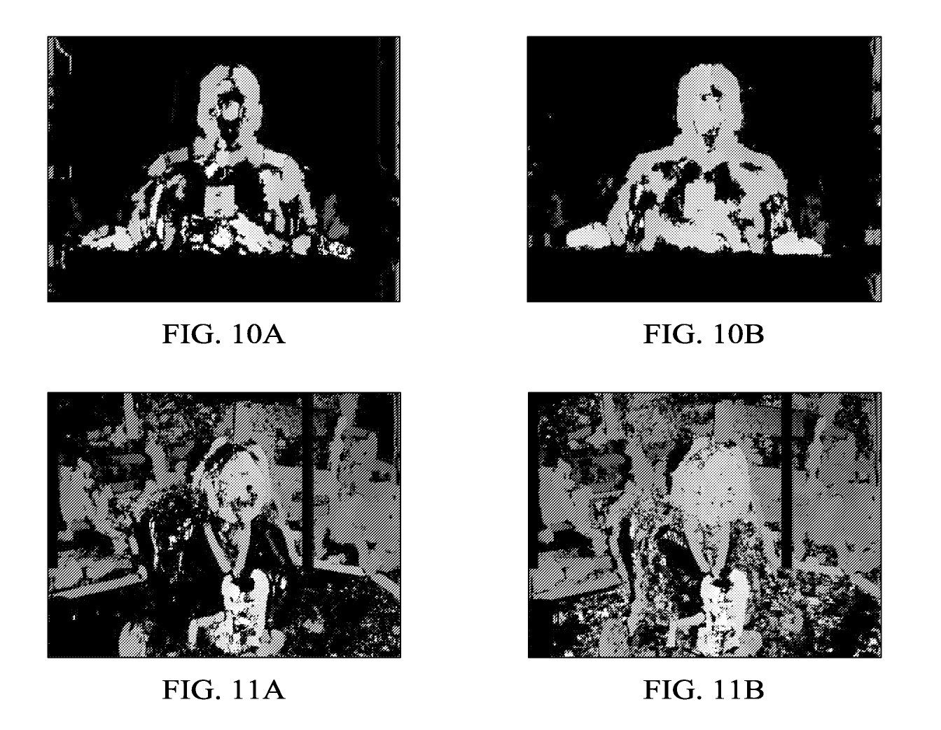

FIGS. 6-8 and 9A-9D are examples illustrating the contrast and brightness matching method. FIGS. 10A, 10B, 11A, and 11B are examples of depth maps before and after color and contrast matching. FIG. 9A and 9B show, respectively, the left and right images before the contrast and brightness matching. FIG. 6 shows the luminance histograms for the images of FIGS. 9A and 9B. Note the differences between the two histograms in terms of the brightness and contrast. FIG. 7 shows luminance histograms of the left and right images after the brightness and contrast matching method is applied. Note how much more these two histograms overlap than the histograms of FIG. 6. FIG. 8 shows the mapping function of the left and right images before and after the contrast and brightness matching as compared to a unity mapping function derived from matching the left image to itself.

FIG. 10A shows a depth map computed for the original left and right images of FIGS. 5A and 5B. FIG. 10B shows a depth map computed after color and contrast matching were both applied. Note that the depth map of 10B is denser than the depth map of 10A. The color and contrast matching also produces denser depth maps when the background is cluttered as is illustrated in the before and after depth maps shown respectively in FIGS. 11A and 11B.

Referring again to FIG. 1, the disparity map computation component 110 includes functionality to compute a disparity map for the stereo image from the color/contrast matched left and right images generated by the color/contrast match component using the disparity range determined by the disparity search range selection component 106. More specifically, the disparity map computation component 110 uses a multiple resolution approach to compute the disparity map in which a disparity map is computed at the resolution of the left and right images and one or more disparity maps computed at progressively lower resolutions are used to fill holes in the largest disparity map. When a single disparity range is provided by the disparity search range selection component 106, all of the disparity maps are computed using that disparity search range. When multiple disparity search ranges are provided, disparity maps using each disparity range are computed and combined into a single disparity map at each level of resolution. The number of lower resolution disparity maps used may be empirically determined and may depend on factors such as image resolution, available processing power, throughput requirements, etc. Any suitable stereo correspondence algorithm may be used to generate the various disparity maps using the disparity search range. In some embodiments, the stereo correspondence algorithm used is a SAD (sum of absolute differences) based matching algorithm.

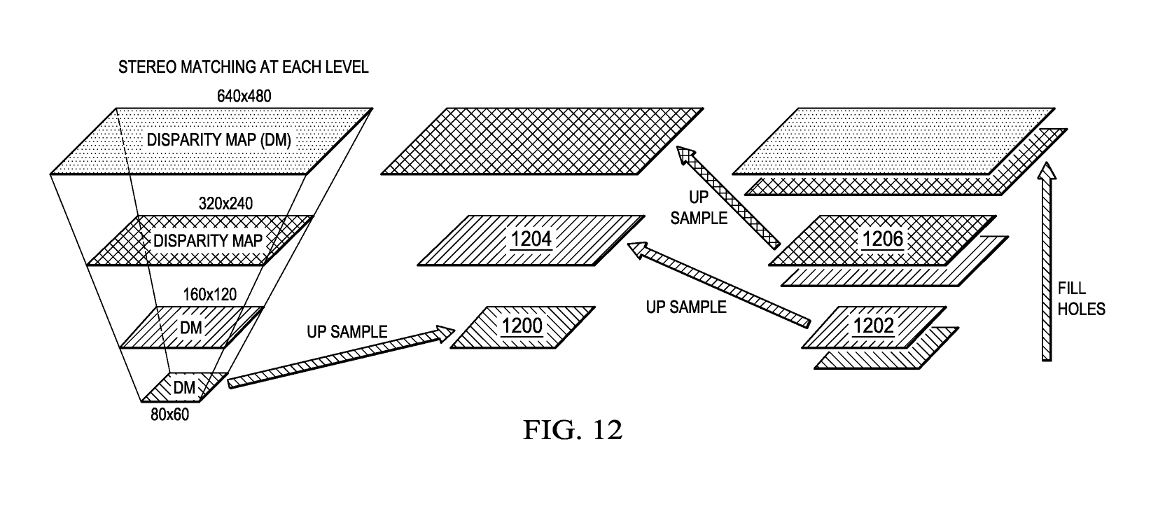

This multi-resolution computation method will now be explained in more detail in reference to the example of FIG. 12. For simplicity of explanation, an input image resolution of 640×480 and the use of three lower resolution disparity maps are assumed. One of ordinary skill in the art will understand embodiments for images of other resolutions and/or that use more or fewer lower resolution disparity maps. Disparity maps are computed at the original 640×480 resolution and at each of the three lower resolutions. Note that at each lower resolution level, the images are down-sampled by a factor of 2 in each dimension from the next high resolution. The lowest resolution disparity map, i.e., the 80×60 disparity map is then upsampled to the resolution of the next higher resolution disparity map. That is, the 80×60 disparity map is upsampled to 160×120. A weighted interpolation is then applied between the 160×120 disparity map and the upsampled disparity map 1200 to fill holes in the 160×120 disparity map. A weighted interpolated disparity value dᵢ is computed as per

dᵢ=αd_{c}+(1−α)dᵤ

where d_{c} is the disparity value in the 160×120 disparity map, dᵤ is the corresponding disparity value in the upsampled disparity map 1200, and α is a weight between 0 and 1. Any suitable value of α may be used. In some embodiments, α=0.5. Further, the value of α may be empirically pre-determined for a specific application.

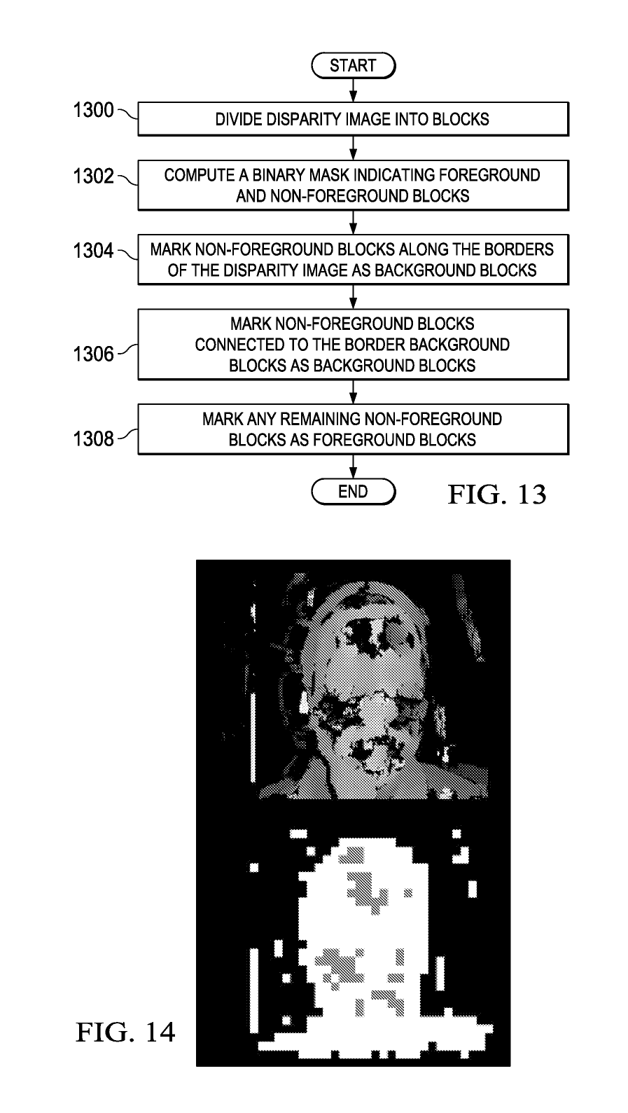

The interpolated 160×120 disparity map 1202 is then upsampled to the resolution of the next higher resolution disparity map, i.e., 320×240. The weighted interpolation is then applied between the 320×240 disparity map and the upsampled disparity map 1204 to fill holes in the 320×240 disparity map in the areas identified by the hole identification process. The interpolated 320×240 disparity map 1206 is then upsampled to the resolution of the highest resolution disparity map, i.e., 640×480. The weighted interpolation is then selectively applied between the 640×480 disparity map and the upsampled disparity map 1206 to fill holes in the 640×480 disparity map. More specifically, the weighted interpolation is performed in specific areas identified by a hole identification process that provides a hole binary mask indicating which areas in the disparity image are to be interpolated. The hole identification process is described below in reference to FIG. 13.

Referring again to FIG. 1, the post-processing component 112 performs processing to further refine the disparity image. This post-processing may include applying one or more of a temporal IIR (infinite impulse response) filter, binary morphology, and a bilateral filter. The temporal filter may be applied to further fill holes in the disparity image by weighted interpolation with disparity values from the disparity image generated for the previous stereo image. The weighted interpolation for a disparity location may be computed as per

dₙ=βdₙ+(1βα)dₙ₋₁

where dₙ is the disparity value in the current disparity map, dₙ₋₁ is the corresponding disparity value in the previous disparity map, and β is a weight between 0 and 1. Any suitable value of β may be used. In some embodiments, β=0.5. Further, the value of β may be empirically pre-determined for a specific application.

The binary morphology operations applied to the disparity image may include erosion and dilation. The bilateral filter may be implemented with any suitable binary filtering technique. Some suitable techniques are described in Q. Yang, et al, “Realtime O(1) Bilateral Filtering,” Computer Vision and Pattern Recognition, IEEE Conference on, pp. 557-564, June 2009, W. Yu, et al., “Fast Bilateral Filtering by Adapting Block Size,” Image Processing (ICIP), 2010 17^{th} IEEE International Conference on, pp. 3281-3284, September 2010, and F. Porikli, “Constant Time O(1) Bilateral Filtering,” Computer Vision and Pattern Recognition, IEEE Conference on, pp. 1-8, June 2008.

In some embodiments, the disparity image may be converted to a depth image prior to application of the post-processing, and the post-processed depth image provided to the end application. In some embodiments, the disparity image may be post-processed as described above, converted to a depth image, and the depth image provided to the end application. In some embodiments, the post-processed disparity image is provided to the end application.

The application component 114 receives the disparity image and performs any additional processing needed for the particular application. The application component 114 may implement any application or applications that rely on a three-dimensional (3D) representation of a scene. For example, the application component 114 may be a 3D reconstruction application that generates a point clouds (a collection of x, y, and z coordinates representing the locations of objects in 3D space) from depth maps. For example, the application component 114 may be an automotive forward collision warning application that calculates how far an object is from the vehicle, tracks the object over time to determine if the vehicle is rapidly approaching it, and warns the driver of an impending collision. In another example, the application component 114 may be an automotive pedestrian detection application. In another example, the application component 114 may be a 3D video conference call application that supports background replacement. In another example, the application component 114 may be a 3D person tracking application. In another example, the application component 114may be a 3D surveillance application.

FIG. 13 is a flow diagram of a method for hole identification in a disparity image. This method generates a hole binary mask indicating blocks of a disparity image that are to be interpolated in the above described multi-resolution depth map generation. As one of ordinary skill in the art will know, the above described interpolation could be applied to all positions in a full resolution disparity image, but such global application could result in increased noise in the final depth map. Knowledge of where the holes are located can be used to pinpoint areas where interpolation might be most effective, thus allowing density improvement while limiting the introduction of noise.

Referring now to FIG. 13, initially, the disparity image is divided 1300 into smaller blocks of disparity values, e.g., square blocks. Any suitable block size may be used. In some embodiments, the block size is chosen to be a multiple of 8 so that all blocks have the same number of pixels in a typical 4:3 or 16:9 aspect ratio image. A binary mask is then computed 1302 that indicates which of the blocks are foreground blocks and which are non-foreground blocks. This binary mask includes one bit for each block in the disparity image, where a high value bit (i.e., a 1 bit) indicates that the corresponding block in the disparity image is a foreground block and a low value bit (i.e., a 0 bit) indicates that the corresponding block is a non-foreground block. One of ordinary skill in the art will understand embodiments in which the bit values for indicating state are reversed.

To determine whether a particular block is a foreground block or a non-foreground block, the number of foreground pixels in the block is counted. A pixel is considered to be a foreground pixel if the disparity of the pixel is less than a minimum background disparity. Any suitable value may be used for the minimum background disparity. Further, the value of the minimum background disparity may be empirically determined for a particular application. For example, in an 8-bit disparity map (where 255 indicates the maximum disparity value), disparities less than 245 may be considered to be foreground pixels.

The foreground pixel count is then compared to a threshold number of foreground pixels to decide whether or not the block contains sufficient foreground pixels to be marked as a foreground block in the binary mask. Any suitable value may be used for this threshold. Further, the value of the threshold may be empirically determined for a particular application and/or a particular block size. For example, for 8×8 blocks, the value of this threshold may be 32.

After all the blocks have been marked as foreground or non-foreground in the binary mask, another binary mask, i.e., a hole binary mask, is generated based on the initial binary mask. The hole binary mask includes one bit for each block in the disparity image, where a high value bit (i.e., a 1 bit) indicates that the corresponding block in the disparity image is a foreground block and a low value bit (i.e., a 0 bit) indicates that the corresponding block is a background block. One of ordinary skill in the art will understand embodiments in which the bit values for indicating state are reversed.

More specifically, the non-foreground blocks are further processed 1304-1308 to decide whether these blocks are part of the background or are indicative of holes in the foreground. Initially, any non-foreground blocks along the borders (i.e., the first and last column of blocks) of the disparity image are marked 1304 as background blocks in the hole binary image. Then, the non-border, non-foreground blocks are analyzed to determine if any are connected to the border background blocks. That is, connected component analysis is used to identify the non-foreground blocks that are connected to a border background block. Any such connected non-foreground blocks are assumed to be part of the background and are marked 1306 as background blocks in the hole binary map. Then, any remaining non-foreground blocks from the initial binary mask are marked 1308 as foreground blocks in the hole binary mask. In addition, the blocks identified as foreground blocks in the initial binary mask are also marked as foreground blocks in the hole binary mask.

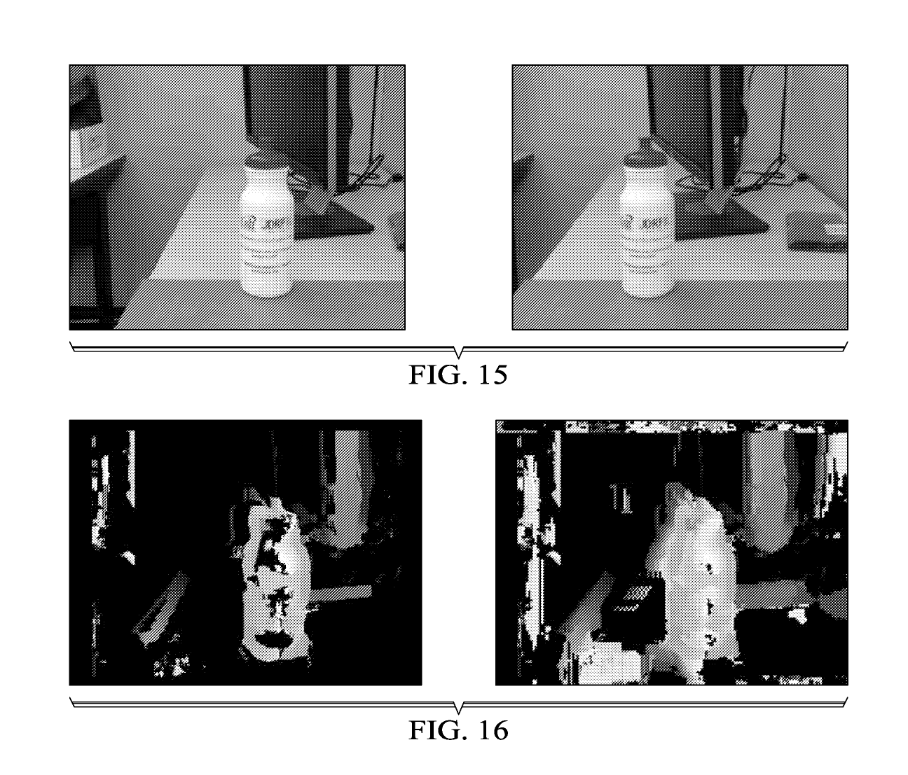

FIG. 14 shows an example of application of this hole identification method. The top image in FIG. 14 shows a disparity image computed from a stereo image pair and the bottom image shows the result of the hole identification. In the bottom image, the foreground blocks are white and the non-foreground blocks that were identified as being part of the foreground, i.e., the holes in the foreground, are “shaded” for illustration purposes. FIGS. 15 and 16 show an example illustrating the application of the above described multi-resolution interpolated disparity computation using a hole binary mask. FIG. 15 shows the input left and right images, the left image of FIG. 16 shows the disparity image after the multi-resolution interpolation has been completed for the lower resolution disparity images, and the right image of FIG. 16 shows the final disparity map after the selective interpolation is performed on the holes identified by the hole binary mask. For this example, two lower levels of resolution, i.e., 320×240 and 160×120, were used in the multi-resolution computation of the disparity map.

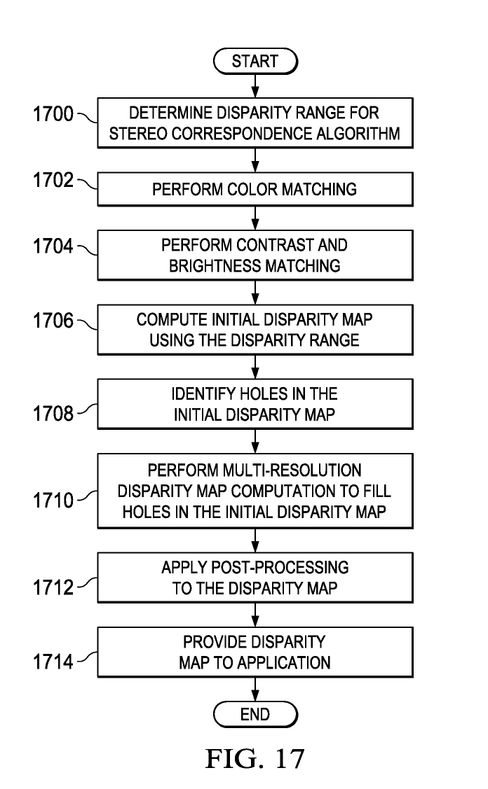

FIG. 17 is a flow diagram of a method for computing a depth map for a stereo image that may be performed for corresponding left and right 2D images of the stereo image. Initially, a disparity range for the stereo correspondence algorithm that is used to compute the disparity image is determined 1700. This disparity range is determined based on the disparity of one or more objects detected in the scene and may be narrower than the default disparity range of the stereo imaging system used to capture the left and right images. In some embodiments, a suitable object detection technique is used to locate an object of interest in each of the left and right images and the disparity of the object in the left and right images is used to determine the correspondence search disparity range. Computation of the disparity of an object detected in left and right images is previously described herein as is determination of a disparity range based on the computed disparity.

In some embodiments, a suitable object detection technique is used to locate an object of interest in one of the left or the right image. A disparity is then computed by comparing the size of the object to the expected size at different distances from the camera as previously described herein. The correspondence search disparity range is then determined based on this disparity. Determination of a disparity range based on the computed disparity is previously described herein.

In some embodiments, the disparity range may be determined based on the disparities of multiple objects in the scene. Such determination of the disparity range is previously described herein.

Color matching is also performed 1702 for the left and right 2D images. Color matching is previously described herein. In some embodiments, the left 2D image is used as the reference image for the color matching. In some embodiments, the right 2D image is used as the reference image for the color matching. After the color matching, contrast and brightness matching is performed 1704 for the color matched left and right 2D images. Contrast and brightness matching is previously described herein. In some embodiments, the left 2D image is used as the reference image for the color matching. In some embodiments, the right 2D image is used as the reference image for the color matching.

An initial disparity map is then computed 1706 for the color and contrast matched left and right 2D images. The stereo correspondence algorithm used to compute the initial disparity map uses the disparity range determined at step 1700. Any suitable stereo correspondence algorithm may be used. Holes are then identified 1708 in the initial disparity map. The output of the hole identification is a hole binary mask identifying areas of the initial disparity image that include holes in the disparity. A method for identifying holes in a disparity image that may be used is described herein in reference to FIG. 13.

Multi-resolution disparity map computation is then performed 1710 to fill holes in the initial disparity map. Multi-resolution disparity map computation is previously described herein. Any suitable number of disparity image resolutions may be used for this computation. At the final stage of the multi-resolution computation, the weighted interpolation is performed on selected areas in the disparity image identified by the hole binary mask as including holes in the disparity image rather than applying the weighted interpolation across the entire disparity image.

Post-processing is then applied 1712 to the disparity image resulting from step 1710 to further refine the disparity image. The post-processing may include one or more of temporal IIR filtering, binary morphology such as erosion and dilation, and bilateral filtering. These options for post-processing are previously described herein. The refined disparity image is then provided 1714 to an application for further processing.

In some embodiments, the disparity image may be converted to a depth image prior to application of the post-processing, and the post-processed depth image provided to the end application. In some embodiments, the disparity image may be post-processed as described above, converted to a depth image, and the depth image provided to the end application. In some embodiments, the post-processed disparity image is provided to the end application.

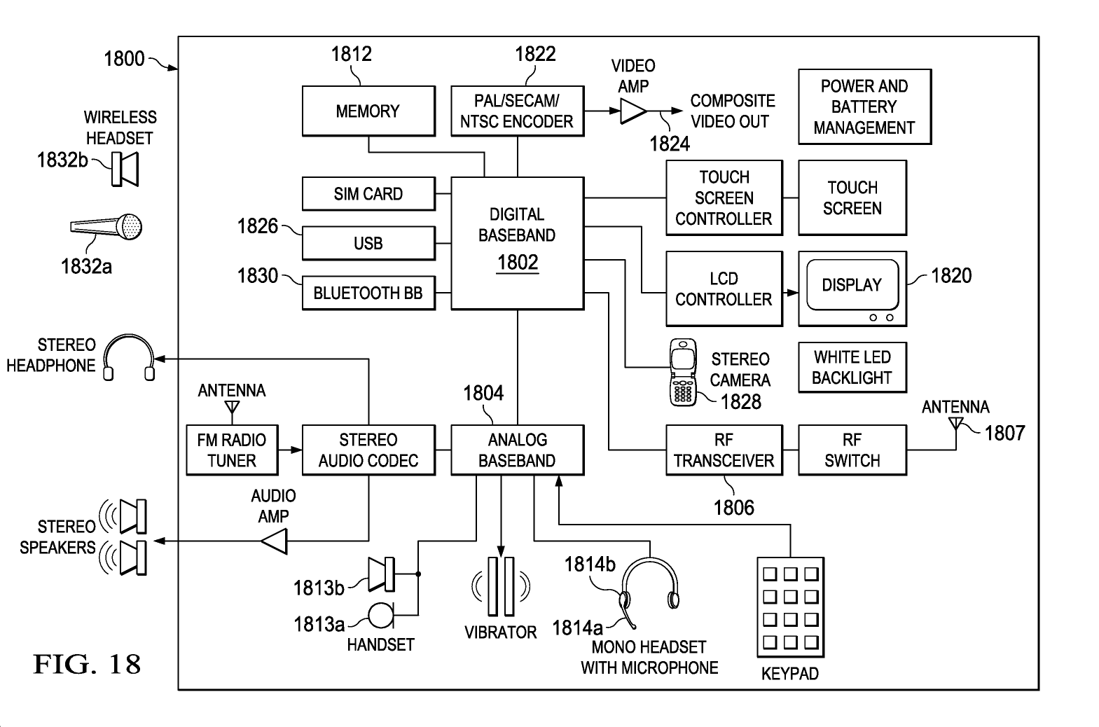

FIG. 18 is a block diagram of an example digital system (e.g., a mobile cellular telephone) 1800 that may be configured to perform compute a depth map for a stereo image as described herein. The digital baseband unit 1802 includes a digital signal processing system (DSP) that includes embedded memory and security features. The analog baseband unit 1804 receives input audio signals from one or more handset microphones 1813a and sends received audio signals to the handset mono speaker 1813b. The analog baseband unit 1804 receives input audio signals from one or more microphones 1814a located in a mono headset coupled to the cellular telephone and sends a received audio signal to the mono headset 1814b. The digital baseband unit 1802 receives input audio signals from one or more microphones 1832a of the wireless headset and sends a received audio signal to the speaker 1832b of the wireless head set. The analog baseband unit 1804 and the digital baseband unit 1802 may be separate ICs. In many embodiments, the analog baseband unit 1804 does not embed a programmable processor core, but performs processing based on configuration of audio paths, filters, gains, etc being setup by software running on the digital baseband unit 1802.

The RF transceiver 1806 includes a receiver for receiving a stream of coded audio data, i.e., a received audio signal, from a cellular base station via antenna 1807 and a transmitter for transmitting a stream of coded audio data to the cellular base station via antenna 1807. The received coded audio data is provided to the digital baseband unit 1802 for decoding. The digital baseband unit 1802 provides the decoded audio signal to the speaker of the wireless headset 1832b when activated or the analog baseband 1804 for appropriate conversion and playing on an activated analog speaker, e.g., the speaker 1814b or the speaker 1813b.

The display 1820 may display pictures and video sequences received from the network, from the stereo camera 1828, or from other sources such as the USB 1826 or the memory 1812. The digital baseband unit 1802 may also send a video stream to the display 1820 that is received from various sources such as the cellular network via the RF transceiver 1806 or the camera 1826. The digital baseband unit 1802 may also send a video stream to an external video display unit via the encoder unit 1822 over a composite output terminal 1824. The encoder unit 1822 may provide encoding according to PAL/SECAM/NTSC video standards.

The digital baseband unit 1802 includes functionality to perform the computational operations of an embodiment of a method for computing a depth map from corresponding left and right images captured by the stereo camera 1828. Software instructions implementing the method may be stored in the memory 1812 and executed by the digital baseband unit 1802.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments are described herein in which the number of levels of resolution used for the multi-resolution disparity map computation is pre-determined. One of ordinary skill in the art will understand embodiments in which the number of levels is dynamically determined based on the size of the object of interest in the scene. In such embodiments, the lowest resolution level may be chosen such that the object of interest is contained within a single matching block at that resolution.

In another example, embodiments are described herein in which the weighted interpolation in the multi-resolution disparity image computation is applied across entire disparity images at the lower resolutions and selective application of the weighted interpolation based on a hole binary mask is performed for the highest resolution disparity image. One of ordinary skill in the art will understand embodiments in which the selective application of the weighted interpolation is performed at one or more of the lower levels of resolution. For example, the hole binary map may be used for selective interpolation of the next lower resolution than the highest resolution disparity map. In another example, a hole binary mask may be computed as per the method of FIG. 13 for a disparity map at each level of resolution for which selective interpolation is to be applied.

In another example, embodiments are described herein in which the gain for R, G, and B to be applied to the non-reference image is computed based on part of the left of the left and right 2D images. One of ordinary skill in the art will understand embodiments in which rather than incurring the overhead of searching for a matching block in the non-reference image, the gain for each of R, G, and B is determined based on the averages of R, G, and B of the entire left and right images. Further, one of ordinary skill in the art will understand embodiments in which the left and right images are divided into suitably sized blocks and the color matching is performed on a block by block basis.

In another example, embodiments are described herein in which a hole binary mask is computed for each image pair. One of ordinary skill in the art will understand embodiments in which, in order to increase throughput, a hole binary mask computed for one stereo pair is reused for subsequent stereo pairs for some period of time, e.g., for 2-4 frames.

Embodiments of methods described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

Although method steps may be presented and described herein in a sequential fashion, one or more of the steps shown in the figures and described herein may be performed concurrently, may be combined, and/or may be performed in a different order than the order shown in the figures and/or described herein. Accordingly, embodiments should not be considered limited to the specific ordering of steps shown in the figures and/or described herein.

It is therefore contemplated that the appended claims will cover any such modifications of the embodiments as fall within the true scope of the invention.

What is claimed is:

1. A method for computation of a depth map for corresponding left and right two dimensional (2D) images of a stereo image, the method comprising:
determining a disparity range based on a disparity of at least one object in a scene of the left and right 2D images;
performing color matching of the left and right 2D images;
performing contrast and brightness matching of the left and right 2D images; and
computing a disparity image for the left and right 2D images after the color matching and the contrast and brightness matching are performed, wherein the disparity range is used for correspondence matching of the left and right 2D images.

2. The method of claim 1, wherein determining a disparity range comprises:
detecting the at least one object in a single 2D image selected from the left 2D image and the right 2D image; and
computing the disparity based on expected sizes of the at least one object at different distances.

3. The method of claim 1, wherein determining a disparity comprises:
detecting the at least one object in the left 2D image and the right 2D image; and
computing the disparity as a difference between a horizontal offset of a bounding box of the at least one object in the left 2D image and a horizontal offset of a bounding box of the at least one object in the right 2D image.

4. The method of claim 1, wherein performing color matching comprises:
computing an average R value, an average G value, and an average B value for each of a reference block of pixels in a reference image and a non-reference block of pixels in a non-reference image, wherein the reference image is one of the left 2D image and the right 2D image and the non-reference image is another of the left 2D image and the right 2D image, and wherein the non-reference block of pixels is a block of pixels in the non-reference image corresponding to the reference block of pixels;
computing an R gain, a G gain, and a B gain as respective ratios of the average R values of the non-reference block of pixels and the reference block of pixels, the average G values of the non-reference block of pixels and the reference block of pixels, and the average B values of the non-reference block of pixels and the reference block of pixels; and
applying the R gain, the G gain, and the B gain to the non-reference image.

5. The method of claim 4, wherein the reference block of pixels is the entire reference image and the non-reference block of pixels is the entire non-reference image.

6. The method of claim 4, wherein performing color matching further comprises:
searching a search area of the non-reference image to locate a block of pixels that best matches the reference block of pixels, wherein the search area is a subset of the non-reference image; and
selecting the block of pixels as the non-reference block of pixels.

7. The method of claim 1, wherein performing contrast and brightness matching comprises:
computing a reference luminance histogram of a reference image and a non-reference luminance histogram of a non-reference image, wherein the reference image is one of the left 2D image and the right 2D image and the non-reference image is another of the left 2D image and the right 2D image;
computing a mapping function to match the non-reference luminance histogram to the reference luminance histogram; and
applying the mapping function to the non-reference image.

8. The method of claim 1, wherein computing a disparity image further comprises:
computing a first disparity image at a first resolution;
computing a second disparity image at a second resolution, wherein the second resolution is lower than the first resolution;
upsampling the second disparity image to the first resolution; and
filling holes in the first disparity image by interpolating disparity values in selected areas in the first disparity image with disparity values in corresponding selected areas in the upsampled second disparity image.

9. The method of claim 8, wherein computing a disparity image further comprises:
computing a hole binary mask for the first disparity image, wherein the hole binary mask identifies holes in the first disparity image, and
using the hole binary mask to identify the selected areas.

10. A stereo image processing system comprising:
a first imaging component arranged to capture a left two-dimensional (2D) image of a scene;
a second imaging component arranged to capture a right 2D image of a scene;
means for performing color matching of the left and right 2D images, wherein performing color matching comprises:
computing an average R value, an average G value, and an average B value for each of a reference block of pixels in a reference image and a non-reference block of pixels in a non-reference image, wherein the reference image is one of the left 2D image and the right 2D image and the non-reference image is another of the left 2D image and the right 2D image, and wherein the non-reference block of pixels is a block of pixels in the non-reference image corresponding to the reference block of pixels;
computing an R gain, a G gain, and a B gain as respective ratios of the average R values of the non-reference block of pixels and the reference block of pixels, the average G values of the non-reference block of pixels and the reference block of pixels, and the average B values of the non-reference block of pixels and the reference block of pixels; and
applying the R gain, the G gain, and the B gain to the non-reference image.
means for performing contrast and brightness matching of the left and right 2D images; and
means for computing a disparity image for the left and right 2D images after the color matching and the contrast and brightness matching are performed.

11. The stereo image processing system of claim 10, wherein the reference block of pixels is the entire reference image and the non-reference block of pixels is the entire non-reference image.

12. The stereo image processing system of claim 10, wherein performing contrast and brightness matching comprises:
computing a reference luminance histogram of a reference image and a non-reference luminance histogram of a non-reference image, wherein the reference image is one of the left 2D image and the right 2D image and the non-reference image is another of the left 2D image and the right 2D image;
computing a mapping function to match the non-reference luminance histogram to the reference luminance histogram; and
applying the mapping function to the non-reference image.

13. The stereo image processing system of claim 10, further comprising:
means for determining a disparity range based on a disparity of at least one object in a scene of the left and right 2D images, and
wherein the means for computing a disparity map uses the disparity range for correspondence matching of the left and right 2D images.

14. The stereo image processing system of claim 13, wherein the means for determining a disparity comprises:
means for detecting the at least one object in the left 2D image and the right 2D image; and
means for computing the disparity as a difference between a horizontal offset of a bounding box of the at least one object in the left 2D image and a horizontal offset of a bounding box of the at least one object in the right 2D image.

15. The stereo image processing system of claim 10, wherein the means for computing a disparity image comprises:
means for computing a first disparity image at a first resolution;
means for computing a second disparity image at a second resolution, wherein the second resolution is lower than the first resolution;
means for upsampling the second disparity image to the first resolution; and
means for filling holes in the first disparity image by interpolating disparity values in selected areas in the first disparity image with disparity values in corresponding selected areas in the upsampled second disparity image.

16. The stereo image processing system of claim 10, wherein the means for computing a disparity image further comprises:
means for computing a hole binary mask for the first disparity image, wherein the hole binary mask identifies holes in the first disparity image, and
means for using the hole binary mask to identify the selected areas.

17. A non-transitory computer-readable medium storing software instructions that, when executed by a processor, perform a method for computation of a disparity map, the method comprising:
performing color matching of the left and right 2D images;
performing contrast and brightness matching of the left and right 2D images; and
computing a disparity image for the left and right 2D images after the color matching and the contrast and brightness matching are performed, wherein computing a disparity image comprises:
computing a first disparity image at a first resolution;
computing a second disparity image at a second resolution, wherein the second resolution is lower than the first resolution;
upsampling the second disparity image to the first resolution; and
filling holes in the first disparity image by interpolating disparity values in selected areas in the first disparity image with disparity values in corresponding selected areas in the upsampled second disparity image.

18. The computer-readable medium of claim 17, wherein computing a disparity image further comprises:
computing a hole binary mask for the first disparity image, wherein the hole binary mask identifies holes in the first disparity image, and
using the hole binary mask to identify the selected areas.

19. The computer-readable medium of claim 17, wherein the method further comprises:
determining a disparity range based on a disparity of at least one object in a scene of the left and right 2D images; and
wherein the disparity range is used for correspondence matching of the left and right 2D images when computing the first and second disparity images.

20. The computer-readable medium of claim 17, wherein performing color matching comprises:
computing an average R value, an average G value, and an average B value for each of a reference block of pixels in a reference image and a non-reference block of pixels in a non-reference image, wherein the reference image is one of the left 2D image and the right 2D image and the non-reference image is another of the left 2D image and the right 2D image, and wherein the non-reference block of pixels is a block of pixels in the non-reference image corresponding to the reference block of pixels;
computing an R gain, a G gain, and a B gain as respective ratios of the average R values of the non-reference block of pixels and the reference block of pixels, the average G values of the non-reference block of pixels and the reference block of pixels, and the average B values of the non-reference block of pixels and the reference block of pixels; and
applying the R gain, the G gain, and the B gain to the non-reference image.
